(19) United States
(12) Patent Application Publication
(10) Pub. No.: US 2002/0101190 A1
(43) Pub. Date: Aug. 1, 2002

(54) Electrodeless aperture lamp with IR shedding

(76) Inventors: Douglas A. Kirkpatrick, Great Falls, VA (US); Robert H. Riedell, Clarksville, MD (US)

Correspondence Address: FUSION LIGHTING INC, PAUL E STEINER, 7524 STANDISH PLACE, ROCKVILLE, MD, 20855

(21) Appl. No.: 10/014,809

(22) Filed: Dec. 14, 2001

Related U.S. Application Data
(60) Provisional application No. 60/255,427, filed on Dec. 15, 2000.

(51) Int. Cl. H05B 41/16

(52) U.S. Cl. 315/246

(57) ABSTRACT

An aperture lamp includes a light transmissive envelope enclosing a discharge forming fill which emits light having both a visible light component and an infrared light component, a first reflector structure surrounding the envelope and defining a visible light transmissive aperture, and a second reflector structure surrounding the envelope and defining an infrared light transmissive aperture, wherein the area of the infrared light transmissive aperture is larger than the area of the visible light transmissive aperture.

### BACKGROUND

1. Field of the Invention

The invention relates generally to electrodeless lamps and more specifically to an electrodeless lamp with novel structures for increasing the proportion of infrared (IR) light emitted from the lamp.

2. Related Art

In general, the present invention relates to the type of lamps described in U.S. Pat. No. 6,137,237 and PCT Application No. PCT/US00/16302, each of which is herein incorporated by reference in its entirety.

### SUMMARY

The following and other objects, aspects, advantages, and/or features of the invention described herein are achieved individually and in combination. The invention should not be construed as requiring two or more of such features unless expressly recited in a particular claim.

One aspect of the present invention involves the separate treatment of infrared and visible radiation in an aperture lamp. It is believed that the amount of IR radiation emitted by the lamp and the corresponding amount of IR radiation absorbed by the bulb and aperture jacket has a relationship with the temperature of the lamp. By controlling the amount of IR radiation emitted, the lamp can be managed to achieve a desired thermal balance. For example, by configuring the lamp to emit a larger portion of IR radiation relative to the visible radiation, the lamp becomes relatively cooler. It follows that such a lamp configuration may be powered at higher levels without overheating the lamp.

Another aspect of the invention involves directing IR radiation through a second aperture, distinct from the visible light emitting aperture. In a projection system, this arrangement has the advantage of directing IR radiation away from downstream optical components.

The above and/or other objects of the invention are achieved by an aperture lamp which includes a light transmissive envelope enclosing a discharge forming fill which emits light having both a visible light component and an infrared light component; a first reflector structure defining a visible light transmissive aperture; and a second reflector structure defining an infrared light transmissive aperture, wherein the area of the infrared light transmissive aperture is larger than the area of the visible light transmissive aperture.

### BRIEF DESCRIPTION OF THE DRAWINGS

The foregoing and other objects, features, and advantages of the invention will be apparent from the following more particular description of preferred embodiments as illustrated in the accompanying drawings, in which reference characters generally refer to the same parts throughout the various views. The drawings are not necessarily to scale, the emphasis instead being placed upon illustrating the principles of the invention.

FIG. 1 is a cross sectional, schematic view of a first example of an IR shedding aperture lamp in accordance with the present invention.

FIG. 2 is a cross sectional, schematic view of a second example of an IR shedding aperture lamp in accordance with the present invention.

FIG. 3 is a cross sectional, schematic view of a third example of an IR shedding aperture lamp in accordance with the present invention.

FIG. 4 is a cross sectional, schematic view of a fourth example of an IR shedding aperture lamp in accordance with the present invention.

FIG. 5 is a cross sectional, schematic view of a fifth example of an IR shedding aperture lamp in accordance with the present invention.

FIG. 6 is a cross sectional, schematic view of a sixth example of an IR shedding aperture lamp in accordance with the present invention.

FIG. 7 is a cross sectional, schematic view of a seventh example of an IR shedding aperture lamp in accordance with the present invention.

FIG. 8 is a cross sectional, schematic view of an eighth example of an IR shedding aperture lamp in accordance with the present invention.

### DESCRIPTION

In the following description, for purposes of explanation and not limitation, specific details are set forth such as particular structures, interfaces, techniques, etc. in order to provide a thorough understanding of the various aspects of the invention. However, it will be apparent to those skilled in the art having the benefit of the present disclosure that the various aspects of the invention may be practiced in other examples that depart from these specific details. In certain instances, descriptions of well known devices, circuits, and methods are omitted so as not to obscure the description of the present invention with unnecessary detail.

In lamps of the type described in the '237 patent, the aperture lamp includes a single source aperture through which all light is emitted. Moreover, all components of light (e.g. UV, visible, and IR) are treated together. The light output of the lamp increases with the RF power applied thereto. The maximum RF power which can be applied to the lamp is limited by the bulb temperature. The inventors have observed that bulbs with smaller apertures reach an aperture window temperature of 950° C. at a lower power than comparably configured bulbs with larger apertures.

The inventors have identified this effect as being due in large part to the amount of IR light emitted by the relatively larger apertures. With smaller apertures, additional IR radiation is absorbed by the ceramic structure encasing the bulb, thereby increasing the bulb temperature. Increasing the size of the aperture emits additional IR waste energy and reduces the total amount of energy that must be conducted through the thermal circuit surrounding the bulb, thereby reducing the bulb temperature. According the present invention, separate treatment is given to the visible and IR components of the light to provide a light source with higher visible light output while maintaining a suitable operating temperature.

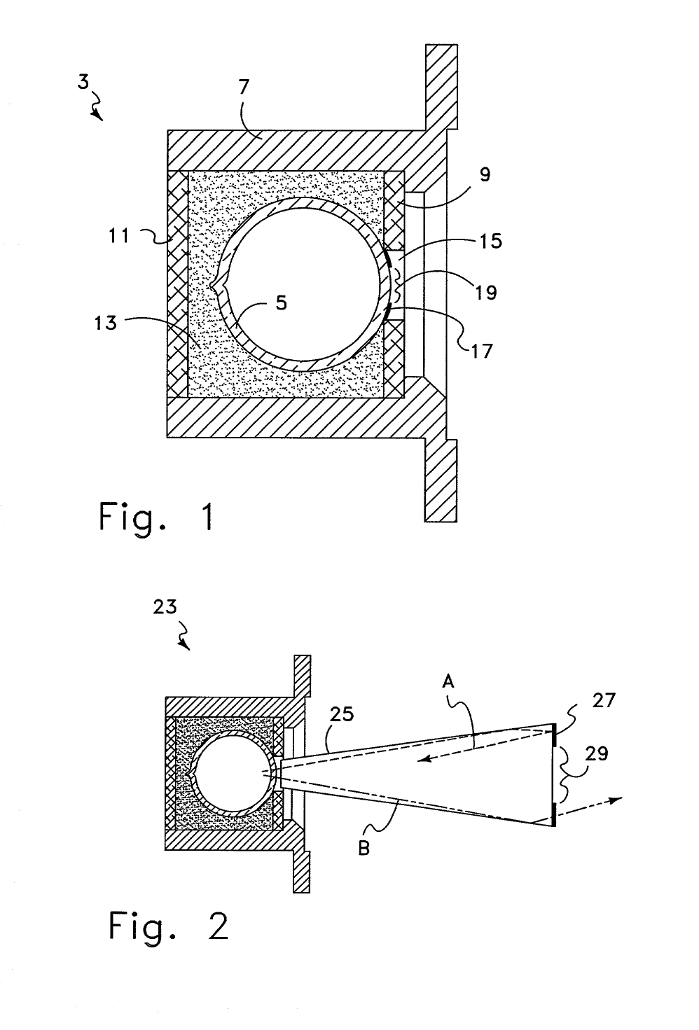

With reference to FIG. 1, an aperture lamp 3 includes a bulb 5 encased in ceramic. In particular the bulb 5 is disposed inside a ceramic cup 7 between a front washer 9 and a back washer 11 and is encased in reflective ceramic material 13. The front washer 9 defines a light transmissive aperture 15. In accordance with the present aspect of the invention, a reflector 17 is disposed on the bulb 5 in the region of the aperture 15. The reflector 17 defines a second aperture 19. The reflector 17 is configured to reflect visible light and to pass IR light. For example, the reflector 17 is made from a high temperature dichroic coating.

As noted in the '237 patent and the '302 application, alumina and boron nitride (BN) are examples of suitable materials for the cup 7. Alumina, silica, and mixtures thereof are examples of suitable materials for the reflective ceramic material 13. Where the cup 7 is made from BN, alumina is a suitable material for the front and back washers 9, 11.

With the smaller interior aperture 17, the light emitting area for visible light is smaller than the light emitting area for IR light. The lamp 3 has the visible light performance of a lamp with a smaller aperture and the thermal performance of a lamp with a larger aperture. This allows the lamp 3 to be operated at higher power levels with corresponding increases in light output and source brightness. The increased brightness leads to higher light output into a target etendue, which may be important to achieving better performance parameters for low cost projection displays.

With reference to FIG. 2, an aperture lamp 23 is similarly configured as described above. However, instead of the reflector 15 on the bulb 5, an optical element 25 with a remote reflector 27 is used to shed the excess IR light. The reflector 27 defines a remote aperture 29 which transmits visible light. The reflector 27 is made, for example, from an IR-transmissive, visible-reflective coating deposited on the end of the optical element 25 in a desired pattern. Alternatively, the reflector 27 may be made from a cold mirror (i.e. a mirror that reflects visible and passes IR) with the aperture 29 defined therethrough and affixed to the end of the optical element 25. The optical element 25 is illustrated as a tapered light pipe (TLP), but alternatively may comprise a compound parabolic concentrator (CPC), an integrating rod, or other solid or hollow optical element. Visible light A which encounters the reflector 27 is reflected back to the light source while IR light B which encounters the reflector 27 passes through the reflector 27.

As compared to the first example, the second example may be preferred for the following reasons. First, the range of angles incident at the end of the optical element 25 is significantly less than the range of angles present at the bulb aperture 13. Second, the temperature at the end of the optical element 25 is much lower than the temperature on the bulb surface. Accordingly, coating or reflector materials may be better optimized with respect to optical characteristics for the reflector 27 as compared to the reflector 15.

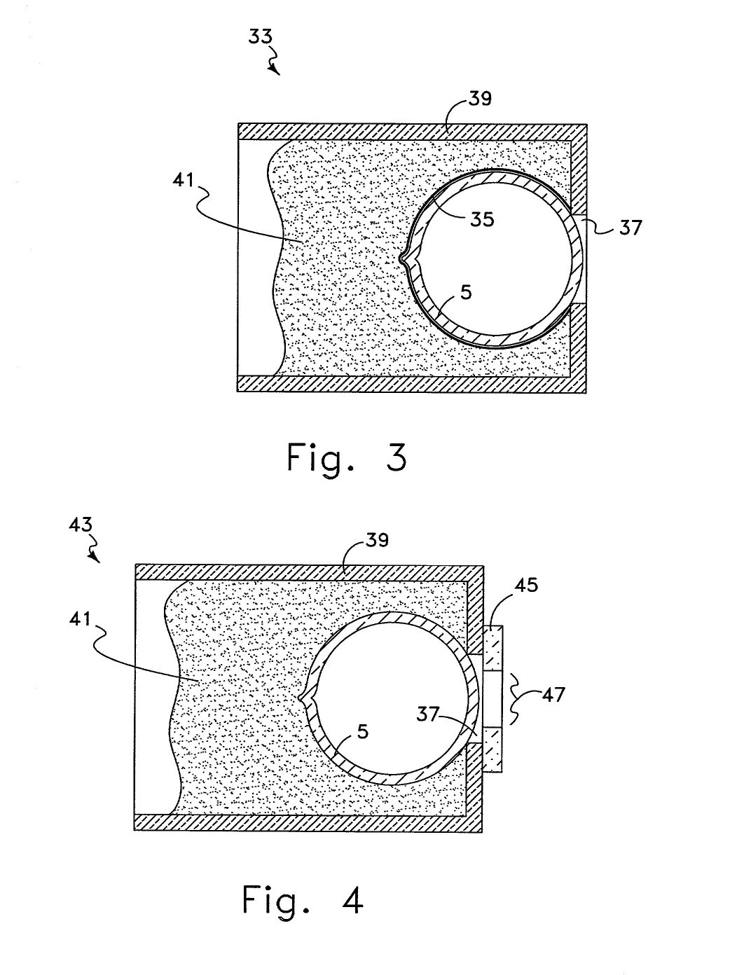

With reference to FIG. 3, an aperture lamp 33 includes an IR reflective coating 35 disposed on the exterior surface of the bulb 5 except in the region of a light emitting aperture 37. The lamp 33 includes a ceramic cup 39 which is open on open end and closed on the other end except for the light emitting aperture 37. When the cup 39 is made from alumina, additional alumina washers are not necessary. The bulb 5 is disposed inside the cup 39 and against the aperture 37. The bulb 5 is encased in reflective ceramic material 41. The IR-reflective coating 35 increases the amount of IR which is emitted from the lamp 33 and correspondingly decreases the amount of IR which is absorbed by the ceramic material 41. The coating 35 is not necessarily 100% or even highly IR reflective, but provides higher IR reflectivity than the bulb 5 and ceramic material 41 alone. The IR-reflective coating 35 may be used alone or in conjunction with other IR shedding structures (e.g. the other examples described herein).

In each of the foregoing examples, the physical size of the bulb aperture must be modified to provide for additional IR emission. In accordance with the present aspect of the invention, the amount of IR emission is increased without otherwise changing the aperture size for visible light output.

With reference to FIG. 4, an aperture lamp 43 is similar to the lamp 33, except without the coating 35. A cold mirror 45 with an aperture 47 defined therethrough is positioned over the cup aperture 37. Accordingly, the cup aperture 37 defines the IR transmissive aperture and the cold mirror aperture 47 defines the visible light transmissive aperture.

With reference to FIG. 5, an aperture lamp 53 includes a bulb 5 disposed inside a ceramic cup and encased with reflective ceramic material 55. The cup defines a visible light aperture 37 which has a desired size for an application. The reflective material 55 defines a second aperture 57. A coating 59 is disposed on the bulb 5 in the region of the second aperture 57. Alternatively, the coating 59 may be disposed over the entire exterior surface of the bulb 5 except in the region of the aperture 37. The coating 59 is configured to reflect visible light and transmit IR light. Advantageously, the IR light is shed out of the back of the bulb away from downstream optics. This reduces the temperature rating required by such optics and may allow the use of more non-quartz (e.g. glass or plastic) in the optical train. A hot mirror (i.e. visible transmissive and IR reflective) or suitable coating may also be used in the area of the visible light aperture 37 to redirect more of the IR light out of the second aperture 57.

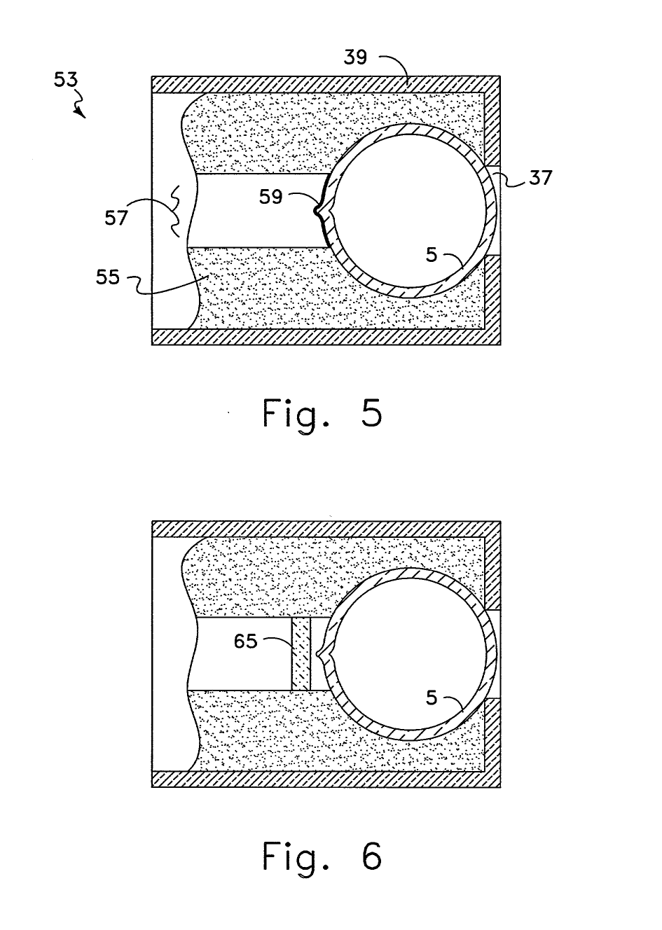

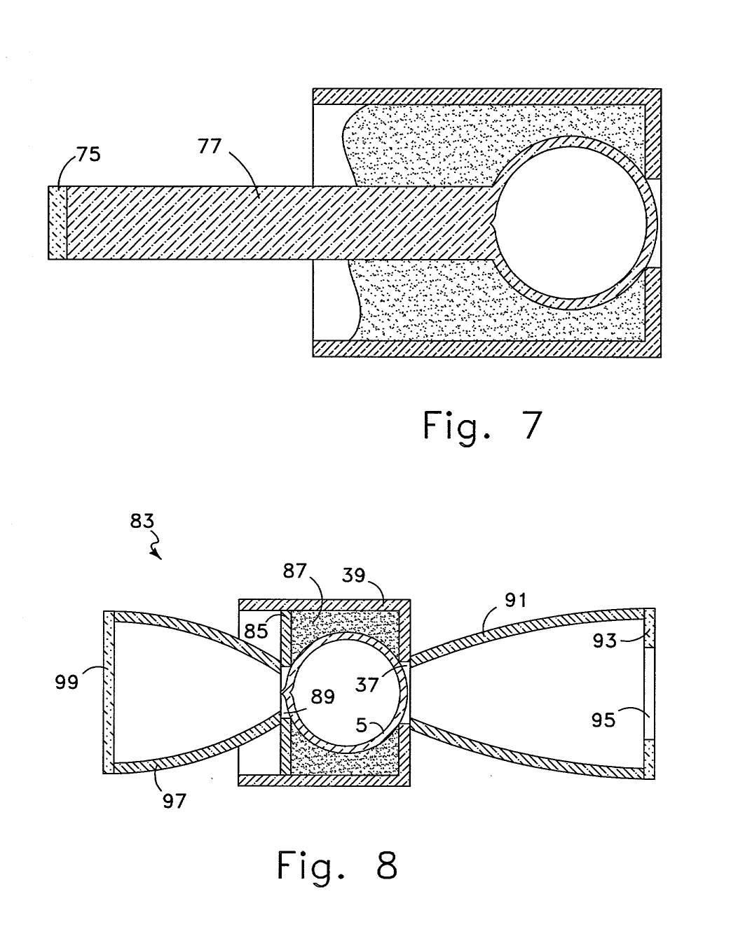

With reference to FIG. 6, instead of the coating 59, a cold mirror 65 positioned close to the bulb 5 is used to pass IR and to reflect visible light back into the bulb 5. With reference to FIG. 7, a cold mirror or coating 75 is disposed on the end of an optical element 77 (e.g. a light rod).

Any of the foregoing examples of FIGS. 5-7 may be used in combination with the remote aperture structure of FIG. 2. For example, with reference to FIG. 8, an aperture lamp 83 includes the bulb 5 disposed in the ceramic cup 39 between the aperture 37 and a back washer 85. The bulb 5 is further encased in reflective ceramic material 87. The back washer 85 defines a second aperture 89. A first hollow CPC 91 is positioned with its narrow end over the aperture 37 and has a reflector 93 affixed to its other end. The reflector 93 defines a remote aperture 95 which transmits visible light (e.g. through a projection system). The other portions of the reflector 93 are configured to reflect visible light back to the bulb 5 and to pass IR light. For example, the reflector 93 is a cold mirror with a hole provided therein defining the aperture 95. A second hollow CPC 97 has its narrow end positioned over the second aperture 89 and has a reflector 99 affixed to its other end. The reflector 99 is configured to pass IR light and to reflect visible light back to the bulb 5. For example, the reflector 99 is a cold mirror.

While the invention has been described in connection with what is presently considered to be the preferred examples, it is to be understood that the invention is not limited to the disclosed examples, but on the contrary, is intended to cover various modifications and equivalent arrangements included within the spirit and scope of the inventions.

What is claimed is:

1. An aperture lamp, comprising:
a light transmissive envelope enclosing a discharge forming fill which emits light having both a visible light component and an infrared light component;
a first reflector structure defining a visible light transmissive aperture; and
a second reflector structure defining an infrared light transmissive aperture,
wherein the area of the infrared light transmissive aperture is larger than the area of the visible light transmissive aperture.

2. The aperture lamp as recited in claim 1, wherein portions of the first reflector structure and the second reflector structure are co-extensive.

3. The aperture lamp as recited in claim 1, wherein at least a portion of the infrared red light is emitted from the lamp in a first direction which is different from a second direction of the visible light.

4. The aperture lamp as recited in claim 1, wherein the second reflector structure comprises a reflective ceramic material which surrounds the envelope except for a region which defines the infrared light transmissive aperture and wherein the first reflector structure comprises a remote reflector which is adapted to reflect visible light and transmit infrared light.
